(19) United States
(12) Patent Application Publication
(10) Pub. No.: US 2008/0113711 A1
(43) Pub. Date: May 15, 2008

(54) Games of chance with at least three base wagers and optional bonus wager

(75) Inventors: Ofir Ventura, Las Vegas, NV (US); Roger M. Snow, Las Vegas, NV (US)

Correspondence Address: Mark A. Litman & Associates, P.A.;Suite 205, York Business Center, 3209 West 76th Street, Edina, MN, 55435, US

(73) Assignee: Shuffle Master, Inc.

(21) Appl. No.: 11/598,924

(22) Filed: Nov. 13, 2006

(51) Int. Cl. G06F 17/00

(52) U.S. Cl. 463/16; 273/292

(57) ABSTRACT

In a poker-style card game, an Ante is placed by a player to participate in a high-low poker type game against a high-hand pay table and a low-hand pay table. A first portion of a player hand is revealed to the player. The player elects to fold, or place a first Play wager that is a multiple of the Ante wager. The multiple is selected at the option of the player. A second portion of the cards is revealed to the player. The player once again elects to fold or place a second Play wager that is a multiple of the first Play wager. The multiple is selected at the option of the player. A third portion of the players hand is revealed to the player and the hands are resolved against a high-hand pay table with corresponding payout odds, and a low-hand pay table with low ranking hands and corresponding payout odds. An optional side bet on a player hand is offered.

### 1. FIELD OF INVENTION

The present invention relates generally to wager-based gaming and more specifically, to games in which a gamer wagers and plays against fixed odds. In particular, the present invention relates to variations of poker games in which a player may place wagers that are multiples of the previous wager made in a game.

### 2. BACKGROUND OF THE ART

Casinos are constantly searching for and developing new games that will add diversity and excitement to their current games menus. Typically, casinos prefer games that will maintain the interest of their existing customers and draw in new customers. Due to the enduring popularity of poker, casinos are always on the lookout for poker-style card games that will attract and retain clientele.

Naturally, different people have different likes and dislikes about games. In poker-style games, some people like live format games while others prefer automated or computerized games. Some individuals enjoy competing against a dealer or other players, while others prefer playing against predetermined winning hand combinations with corresponding odds payouts. Some players prefer poker-style games in which any outcome is based solely upon five cards, while others enjoy the flexibility of being able to discard and receive replacement cards, or play games that use a different number of cards than five.

An example of a poker-style card game is described in U.S. Pat. No. 6,206,373 (hereinafter “the '373 patent”). In that game, play begins with a predetermined dealer card, such as an Ace. The dealer receives one additional card, face-up. Each participant receives two cards. In addition, five community cards are dealt, face-down. The participants are provided with opportunities to increase their bet from an original ante before the identity of each community card is revealed. Each participant's two individual cards and the “best” three community cards are then compared to the dealer's hand, which includes the dealer's two cards and the “best” three community cards. Awards are granted to gamers whose poker hands beat the dealer's hand.

The poker-style game of the '373 patent may be undesirable to some gamers because it does not provide opportunities to wager that the player will obtain a predetermined winning hand, as the rules require the player's hand to beat the dealer's hand to win. Moreover, playing five out of seven cards, rather than receiving and playing a game with five cards may be undesirable to some players.

Fulton U.S. Pat. No. 5,251,897 discloses a game in which players place an ante wager and receive a plurality of cards. After viewing the cards, each player has an opportunity to increase the wager. At least one additional card is received, and the player hand is then resolved against a pay table.

Published U.S. application 2006/0025191 A1 discloses a method of playing a wagering game, comprising a step of a player placing a first Ante wager to participate in the wagering game. At least a partial hand of cards is dealt to each player. A set of winning outcomes and corresponding payout odds is provided. The set of winning outcomes includes at least one predetermined minimum high ranking hand and at least one predetermined maximum low ranking hand. Additional cards are dealt, if necessary to complete each player hand. Each player is paid a payout on the Ante wager for obtaining a winning outcome without requiring the player to make an election as between having at least one predetermined minimum high ranking hand and at least one predetermined maximum low ranking hand. Some of the embodiments of the game allow the placement of a Play wager after the player sees at least a partial hand of cards.

It would be desirable to provide a high-low poker type game that includes a unique betting structure that rewards players who make larger wagers early in the game, and also allows the player to play against a “high” pay table, a “low” pay table, or both.

### SUMMARY OF THE INVENTION

A method of playing a casino card game is disclosed. The game in its broadest sense includes the step of each player making an Ante wager to participate in the game. According to the invention, each player receives at least a partial hand of cards. The partial hand may be in the form of player-dealt cards, community cards, cards selected by a player, special hands or the like. The player views the received cards. After the first portion of the hand is reviewed, the player makes a first Play wager that is a multiple of his Ante wager or folds. The multiple may be 1× or more of the Ante wager, at the option of the player. The player then views a second portion of his hand. The cards may be viewed by the dealer exposing the cards, the player picking up the cards, or by other means. After the second portion of his hand is viewed, the player makes a second Play wager that is a multiple of his first Play wager or folds. The second Play wager may be 1× or more of the first Play wager, at the option of the player. The player views a final portion of his hand, and then the hand is resolved. Players are paid when a composition of the player's final hand meets or exceeds a predetermined minimum winning rank, meets or is below a predetermined maximum rank, or both.

Other features and advantages of the present invention will become apparent to those of ordinary skill in the art through consideration of the ensuing description, the accompanying drawings, and the appended claims.

### BRIEF DESCRIPTION OF THE DRAWINGS

The drawings depict non-limiting embodiments of various aspects of the present invention, including:

FIG. 1 is a flow diagram depicting features of one embodiment of the game of the present invention;

FIG. 2 depicts a betting layout for a game that incorporates teachings of an embodiment of the present invention;

FIG. 3 shows a betting layout for an alternate game that incorporates teachings of the present invention;

FIG. 4 shows an exemplary game, where three player cards are dealt to each player position;

FIG. 5 illustrates a step of revealing first a community card;

FIG. 6 illustrates a step of revealing a second community card;

FIGS. 7-9 show various views of an embodiment of the game executed on a multiple player interactive gaming platform; and

FIGS. 10-12 illustrate an exemplary control system for the interactive gaming platform.

### DETAILED DESCRIPTION OF THE INVENTION

A method of playing a casino card game is disclosed. According to the invention, the method includes the step of each player making an Ante wager to participate in the game. At the same time as the Ante wager is made, the player may optionally enter a side bet on the occurrence that all or part of the player hand will form one of a plurality of predetermined winning payouts. This optional wager will be described in more detail below. According to the invention, the player receives at least a partial hand of cards. The receipt of cards may be in the form of the player being handed cards, the player electing to play a specific set of cards, or the dealer revealing community cards to the player. The player may make a wager on a separate hand, such as a “dragon hand”, or may receive cards when the cards are displayed on a player monitor or common display.

With knowledge of a portion of the player hand, the player has the option of folding, where he forfeits his Ante and his optional side bet wager, or making a first Play wager. This first Play wager may be a multiple of his Ante wager. Generally, it is within the player's total discretion to make a first Play wager that is a multiple of the Ante. The multiple can range from 1 to 5 and is typically a multiple of 2. Thus, the player selects a first Play wager that is typically 1× or 1× the Ante, at the player's sole discretion. It is sometimes necessary for the house to impose restrictions on when the player can make a first Play wager in excess of the Ante amount. For example, the game may require that the player qualify with a pair of 2's or better in the portion of the hand viewable by the player to double down, triple down, or quadruple down, for example.

According to the invention, the player views a second portion of his hand, by any of the previously described means for viewing the cards. After the second portion of his hand is viewed, the player makes a second Play wager that is a multiple of his first Play wager or folds. An inventive feature of the present invention is the rule that permits the player to make a second play wager that is a multiple of his first play wager. According to this format, the player who wagers more aggressively early in the game is rewarded by permitting the player to wager more than other players later in the game, allowing for higher payouts on wins. Since the payouts are based on posted odds, players who wager the most aggressively will win the highest payouts.

According to the invention, the player then views a final portion of his hand. It is to be understood that even though only two Play wagers are described, games with more wagering rounds that permit additional play bets, with or without the ability to multiply the wager by the previous wager are contemplated.

The player then views a final portion of his hand. If the number of cards assigned to the player is the same number of cards as will appear in the final hand, the hand ranks are then determined and players are paid a payout on at least one of a high hand pay table, a low hand pay table or both. If the player has not received a final number of cards, additional cards may be dealt, and/or cards may be discarded to form a final hand. Players are paid a payout when a composition of the hand meets or exceeds a predetermined minimum winning rank, meets or is beneath a predetermined maximum rank, or both.

An example of a suitable High-Low pay table for a five card poker game of the present invention is as follows:

TABLE 1

| High Winners | Pays | Low Winners | Pays |
|---|---|---|---|
| Royal Flush | 500:1 | Five High | 50:1 |
| Straight Flush | 50:1 | Six High | 15:1 |
| Four of a Kind | 25:1 | Seven High | 5:1 |
| Full House | 10:1 | Eight High | 3:1 |
| Flush | 7:1 | Nine High | 2:1 |
| Straight | 5:1 | Ten High | 1:1 |
| Three of a Kind | 3:1 | | |
| Two Pair | 2:1 | | |
| Tens or Better | 1:1 | | |

| | |
|---|---|
| House Edge | 2.69% |

Although a five-card pay table is illustrated, it is to be understood that betting formats of the present invention can be incorporated into games utilizing fewer than 5 cards or more than five cards. For example, the game might be a 3, 4, 6, 7 or even 8 card game, using 0, 1, 2, 3, 4, 5, 6, or 7 common cards, special hands, player designated hands or other sources of cards. Other poker ranking systems for hands of fewer than or more than five cards are known in the art.

In one preferred form of the invention, at least a portion of the hand comprises community cards. This is done for security reasons. The fewer cards that are handled by the players, the less chance there is for cheating. One form of the invention utilizes three common cards in the game.

When community cards are used, it is often desirable to deal at least some of the cards to each player. This feature lowers the volatility of the game for the house, as all players will not win or lose as a group. A preferred number of player-specific cards are two. It might be desirable to provide one or more extra cards to either the common card group or to the player hand and allow the player to discard one or more cards. This rule would necessarily require the house to raise the ranking of the winning hands or lower the payout odds to compensate for the player's ability to improve his hand.

At any point in the game, one or more extra cards may be dealt and the player may be allowed to discard a card. As with the previously described rules, the pay tables would require adjustment, but this modification is well within the scope of the present invention.

In a less preferred form of the invention, the player is required to make an election to play against a high pay table or a low pay table. The player may indicate this election to the dealer by placing the wager in an area designated for high pay table or low pay table action. In other embodiments, the dealer queries the player and places a marker on an area designated “high” or “low” for each player. In one preferred form of the invention, the player is not required to make an election, and is permitted to play simultaneously against both pay tables. This rule advantageously deters the player from folding out of the game, assuring the casino statistically higher profits.

In the pay table shown above, there is no overlap in winning hands between the high hand and low hand pay tables. That is, the player can only win on one pay table at a time. In other forms of the invention, the player may hold a hand that qualifies for payment on both pay tables. An exemplary hand would be a pair of 5's. The house rules will dictate whether the player is paid on the high hand, the low hand or both. In one example, the player wins both payouts.

Games of the present invention may include the dealing of two player-specific hands to the players and three community cards, to play a five-card poker style game. Although the house may place restrictions on when a player can place any play wager that is more than 1× the last wager made (except for a bonus wager), a preferred method allows the player to bet Multiples, by doubling down, tripling down, quadrupling down, etc. at will.

One exemplary multiple for both the first Play wager and the second Play wager is 1 or 2. However, the first and second Play wagers may be multiples selected from the group consisting of: 1, 2, 3, 4 or 5. An exemplary game is played where the player places an Ante, a first Play wager of 1× or 1× the Ante, and a second play wager of 1× or 2× the first play wager, the multiples being chosen by the player.

According to the present invention, the basic game can be enhanced by offering one or more separate side bet wagers. One such side bet wager is made on the occurrence of the first three player-specific cards being a predetermined winning three-card poker hand. Exemplary pay tables are as follows:

TABLE 2

| Three Card Bonus Set | Pays |
|---|---|
| Royal Flush | 50:1 |
| Straight Flush | 40:1 |
| Three of A Kind | 30:1 |
| Straight | 6:1 |
| Flush | 4:1 |
| Pair | 1:1 |
| House Edge | 2.14% |

TABLE 3

| Three Card Bonus Set | Pays |
|---|---|
| Royal Flush | 50:1 |
| Straight Flush | 40:1 |
| Three of A Kind | 25:1 |
| Straight | 6:1 |
| Flush | 4:1 |
| Pair | 1:1 |
| House Edge | 3.31% |

TABLE 4

| Three Card Bonus Set | Pays |
|---|---|
| Royal Flush | 50:1 |
| Straight Flush | 40:1 |
| Three of A Kind | 30:1 |
| Straight | 5:1 |
| Flush | 4:1 |
| Pair | 1:1 |
| House Edge | 5.39% |

TABLE 5

| Three Card Bonus Set | Pays |
|---|---|
| Royal Flush | 50:1 |
| Straight Flush | 40:1 |
| Three of A Kind | 30:1 |
| Straight | 6:1 |
| Flush | 3:1 |
| Pair | 1:1 |
| House Edge | 7.10% |

The player may optionally improve his three-card hand with an extra draw and discard step, or by using one or more community cards in place of cards dealt directly to the player. If the player folds rather than making the required Play wagers, this bet is typically forfeited to the house. In other embodiments, this wager remains in play even though the player checks on the Ante and any Play wagers in play.

Other side bets that are contemplated include progressive side bets, side bets that pay a fixed bonus amount, side bets that pay a randomly determined bonus amount, and side bets that pay odds payout amounts for premium hands. An example of a premium payout side bet would be a side bet that would pay odds on a Royal Flush, a Straight Flush, and Three of A Kind, in a three-card bonus hand. One preferred progressive side bet would be based on a player's five card hand. The top ranking hand is a five card Royal Flush and a total amount displayed on the progressive meter would be paid to a player achieving this hand. Within the same bonusing system, lower ranking hands would pay a small percentage of the progressive jackpot, i.e. 10%, or fixed amounts.

Other embodiments of the present invention allow the player to check in addition to making Play wagers or folding.

According to the present invention, the game may be played as a live table game or may be executed by a computer based gaming system. One exemplary computer based gaming system is Shuffle Master, Inc.'s Table Master™ multi player platform. This platform allows multiple players to engage in an interactive game such as the game described above. Aspects of the control system are disclosed in Published application. 2005/0164759 A1. The content of this application is incorporated by reference herein.

The present invention may be characterized as a computerized video gaming machine, comprising: a plurality of player stations, a player display at each player station and a processor programmed to execute one or more of the game methods described above. The game may be presented on a stand-alone video game machine, on a hand-held game play device, on a wireless gaming platform, as an internet gaming game, as a parlor game, as a game show format or in any other known gaming format.

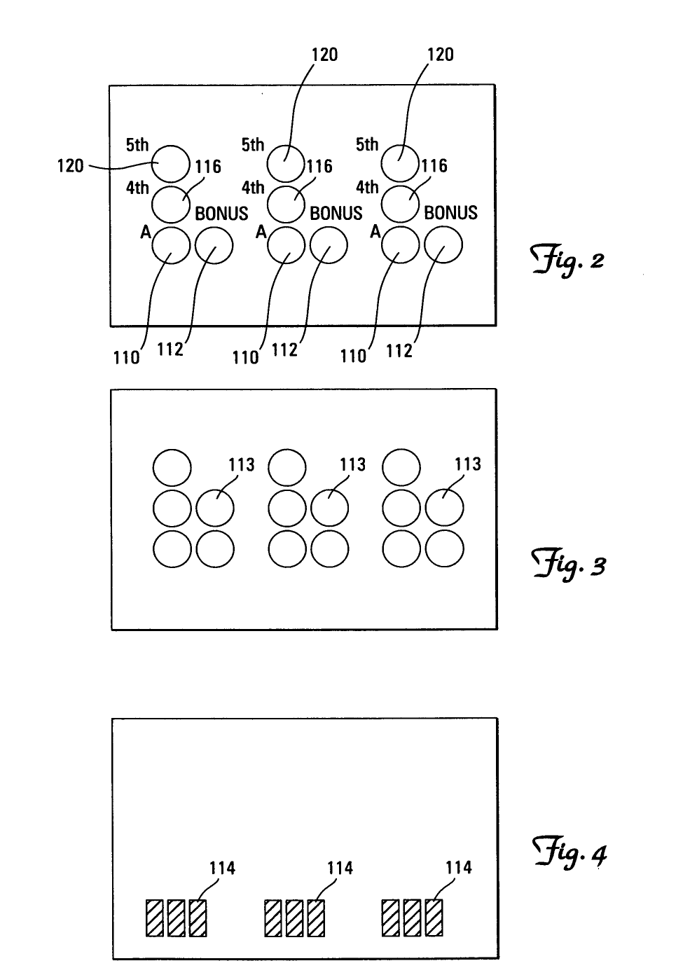

To further understand the invention, an example of an embodiment of the game is presented below. With reference to Figure, a flow chart is presented which show an embodiment of the present invention. FIGS. 2 through 7 additionally illustrate a selected area of the table layout and show various stages of such a game. In the depicted embodiment, the game is a five card poker game in which three individual cards are dealt to each participating player. A total of two community cards are dealt. Thus, each participant's “hand” of five cards includes the three cards that have been dealt to the player, as well as the two community cards, which are shared by the participating players.

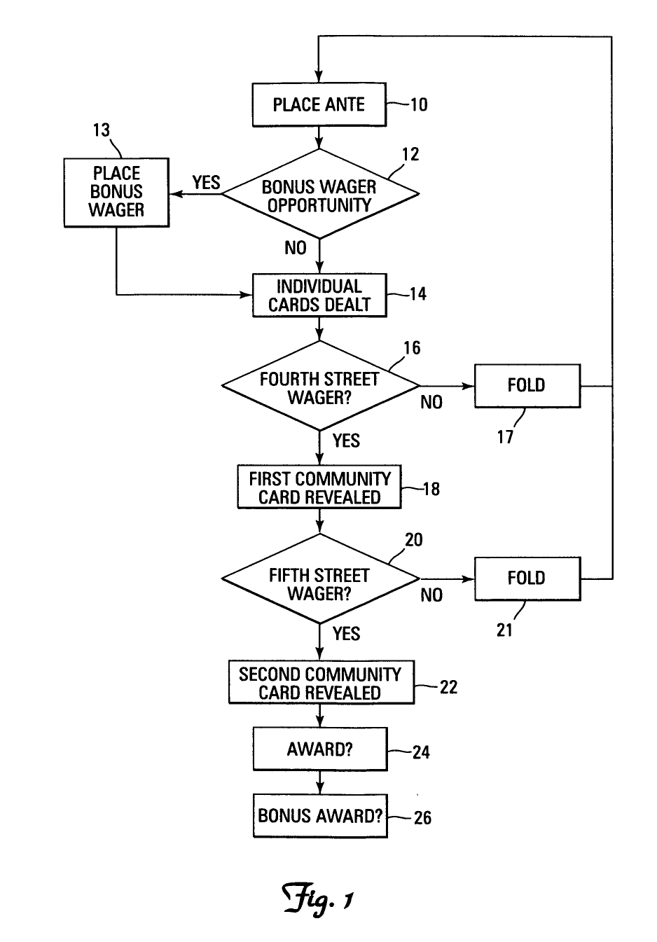

At reference block 10 of FIG. 1, and as shown in FIG. 2, each player who wants to participate in the game places an Ante wager on betting circle 110. Prior to, or after the placement of the Ante wager, each player is given the opportunity at decision block 12 to place a bonus wager on betting circle 112, and reference block 13 of FIG. 1. As shown in FIG. 3, the player may also be given an opportunity to place additional bonus wagers on additional bonus areas 113 to participate in a super bonus prize such as a progressive jackpot, a randomly determined jackpot amount, a premium hand odds payout or combinations of the above.

Although the bonus wagers are typically made prior to the cards or while the cards are being dealt, opportunities for each player to place a bonus wager may be provided after individual cards have been dealt to each player, after common cards have been dealt or even after the identities of one or more, but not all, of a player's individual cards (e.g., one of three or two of three cards) have been revealed.

After the wagers have been placed 20, individual cards 114 are dealt 14 to each player. Preferably, each player receives three cards, face down, as shown in FIG. 4.

Once individual cards 114 have been viewed, each participating player has a decision to make as shown at decision block 16. Players may either fold as indicated by block 17, or place the first Play wager, referred to in the five card version of the game as the “fourth street” wager 16 in wagering area 116, as shown in FIG. 2.

According to the invention, the player has a choice to wager a multiple of the Ante, such as 1×, 2×, 3×, 4× or 5× the Ante, at the sole discretion of the player. A preferred rule permits the player to select from 1× or 2× the Ante, depending on the strength of his partial hand. The casino may impose restrictions on when the player can increase the first Play wager, but in a preferred form of the invention, the decision is within the complete discretion of the player. Allowing the person to wager more aggressive early in the game is good for the casino, since on the average, the casino earns a percentage of all wagers placed. Higher wagers yield more profit to the casinos.

Since the player is typically simultaneously playing against the high and low pay tables, he or she will only be motivated to fold when the hand is neither good, nor bad. But since the player does not have full knowledge of the hand, the player is less likely to fold when the player is playing against two competing pay tables, which encourages players to stay in the game. If the player does happen to fold, all wagers, including any bonus wagers are lost to the house. In a less preferred embodiment, bonus bets stay in action.

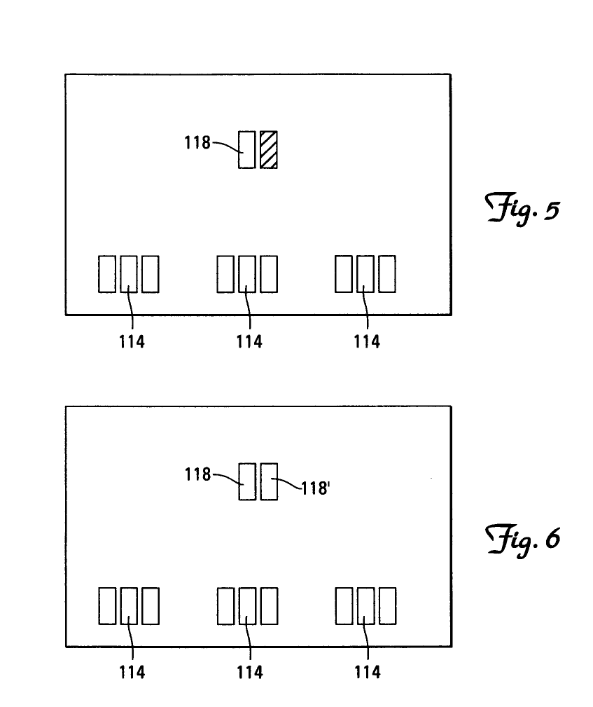

After the first Play wager has been made, a first of two community cards 118 is revealed at block 18 to the players. FIG. 5 shows first community card 118 turned face up. At this point, the player may fold, shown as block 21, or make a second Play wager that in the five card version of the game is called a “Fifth Street” wager 20. The second play wager may be made on betting circle 120, as shown in FIG. 2. According to the invention, the second Play wager is a multiple of the first Play wager. Examples of suitable multipliers are 1×, 2×, 3×, 4×, 5× and larger numbers, and in the present example, the player may select between 1× and 2× the first Play wager. When the game is a five card game, the second Play wager is referred to as a “Fifth Street” wager. The player then chooses to either make a “Fifth Street” wager 20, or fold 21. One preferred method allows the player to select the multipliers for the first and second play wagers without restriction. In other forms of the invention, house rules may require the player to qualify before selecting a multiplier greater than 1×. If the player folds, all wagers in action are lost to the house. In another form of the invention, the bonus wagers remain in action.

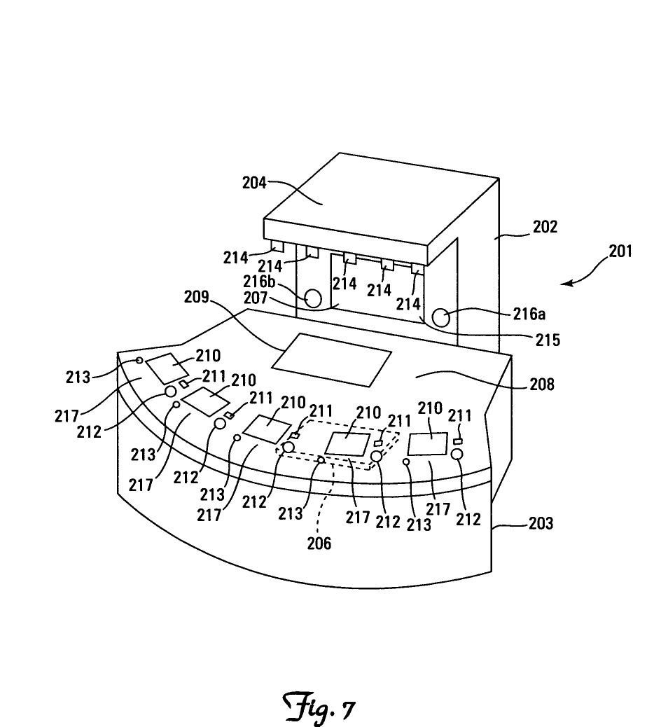

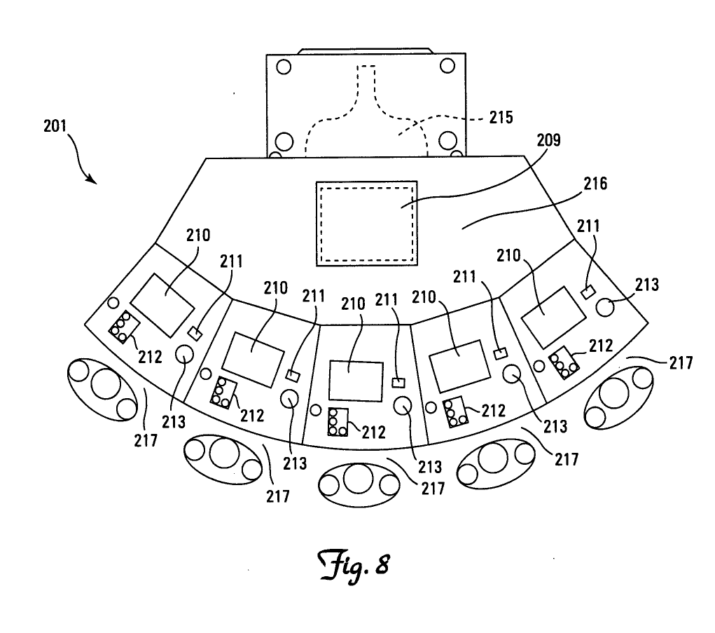

After the “Fifth Street” wager 20 is placed, the second community card 118′ is revealed, as shown in FIG. 6. The individual cards 114 of each player are then considered along with community cards 118 and 118′ to determine whether or not that player receives one or more payouts. The five card poker ranking of each player's combined hand is compared to predetermined winning combinations on two separate pay tables. In a preferred form of the invention, the player hand is compared to both the high hand and low hand pay tables. In resolving the base game, the payout (or payouts) is based on the combined total of his or her ante, “Fourth” and “Fifth Street” wagers. Players who folded are not eligible for payouts.

Base awards may be paid out, at reference 24 of FIG. 1, when a particular player's hand including individual cards 114 and community cards 118 and 118′ are compared with a high pay table (e.g., a table of “winning,” or good poker hands), a low pay table (e.g., a table of “losing,” or poor poker hands), or a combination thereof.

An example of a payout table that may be used in computing base awards follows:

TABLE 6

| High Winners | Pays | Low Winners | Pays |
|---|---|---|---|
| Royal Flush | 500:1 | Five High | 50:1 |
| Straight Flush | 50:1 | Six High | 15:1 |
| Four of a Kind | 25:1 | Seven High | 5:1 |
| Full House | 10:1 | Eight High | 3:1 |
| Flush | 7:1 | Nine High | 2:1 |
| Straight | 5:1 | Ten High | 1:1 |
| Three of a Kind | 3:1 | | |
| Two Pair | 2:1 | | |
| Tens or Better | 1:1 | | |

| | |
|---|---|
| House Edge | 2.69% |

As can be seen from the pay table, a minimum winning high hand is a pair of ten's or better. A maximum low ranking hand that pays is a ten high or better. Any hands that rank between the two minimum and maximum rankings lose. In other embodiments of the game, some selected hands pay on both the high and low pay tables. The game rules may provide in this instance that the player be awarded a) both payouts, b) a highest payout, or c) the lowest payout.

Typically, hands do not pay out simultaneously on both pay tables, and there are a group of middle-range hands that lose, which assures the house has an edge.

Any bonus award, at reference 26 of FIG. 1, in an example of the invention are to be based on the rank and suit of the individual cards 114 (FIG. 3) that have been dealt to a player who placed a bonus wager 112 (FIG. 2) at reference 12 of FIG. 1. The following nonlimiting example of a pay table is based on three card combinations when three individual cards 114 have been dealt to each player:

TABLE 7

| Three Card Bonus Set | Pays |
|---|---|
| Royal Flush | 50:1 |
| Straight Flush | 40:1 |
| Three of A Kind | 30:1 |
| Straight | 6:1 |
| Flush | 4:1 |
| Pair | 1:1 |
| House Edge | 2.14% |

Once all wagers that have not been forfeited to the house have been resolved, game play is complete and, if desired, another game may commence by placing another Ante wager at block 10.

A game of the present invention may be implemented in a variety of formats. As nonlimiting examples, such a game may be a live table game, in which each participant must be present at the table, or be played electronically, in which a live gamer plays against other live gamers, computer-controlled simulated gamers, or a combination of live and simulated games.

An embodiment of an electronic gaming platform 201 suitable for executing games of the present invention is shown in FIG. 7. This type of platform is especially popular in areas where live table games are prohibited, such as in Racinos or where providing sufficient staff to run live table games is not practical, such as in some video poker bars.

The illustrated platform 201 has a curved side 203 for accommodating up to seven garners and a straight side 214 adjacent to an upright cabinet 202. The upright cabinet supports a virtual dealer display 125. The main cabinet 216 supports a common player display 209, and multiple player stations 217. Each player station 217 is equipped with an individual player screen 210, player controls 212, 213 which may be in the form of push button controls or touch screen controls, and a currency acceptor 211.

FIG. 8 shows a top plan view of the system shown in perspective in FIG. 7. Players may view individual cards on player screen 210, and common cards on screen 209. Optionally, common screen 209 displays both common cards and player cards. Final scores, payout amounts, credits available, win/loss histories, pay tables, game rules and the like may be displayed on player screens 210, or common screen 209 or both.

The platform is considered interactive because each player at a player station is engaged in a common game. The game is dealt virtually from a single standard 52-card deck. Each player must wait their turn to play out a hand. The pace of the game is set by the player who is the last one to make the wagering decision. So in these ways, the game is a close simulation to a live game. To add ambiance, a virtual dealer is displayed on screen 215. The virtual dealer makes appropriate statements and gestures consistent with game play.

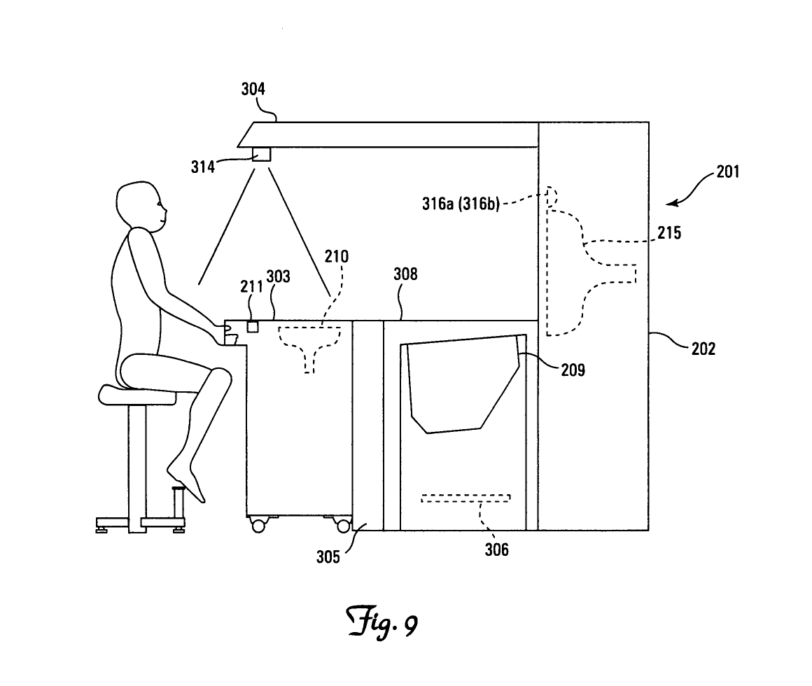

The system shown in FIGS. 7 through 11 is fully disclosed in U.S. patent Publication 2003/0199316 A1, the disclosure of which is hereby incorporated herein, in its entirety, by this reference. As illustrated in FIG. 9, system 201, which has an appearance that resembles that of a conventional casino card table, includes a vertical upright display cabinet 202 and a player bank or station cluster arrangement 303. Vertical display cabinet 202 includes a virtual dealer display 215 on which images of the virtual dealer may be displayed. A top 308 of player bank arrangement 303 includes individual player monitors 210 for each player position, as well and tabletop payment (e.g., coin, cash, credit/debit card, etc.) acceptors 211, and player controls 212 and 213. A separate community card monitor 209 displays community cards 118, 118′ (FIG. 4) in a format large enough for all of the players who are participating in game play at system 201, as well as any nearby onlookers, to view. Speakers 316a and 316b may be provided for sound transmission. Decorative lights 314 may also be provided.

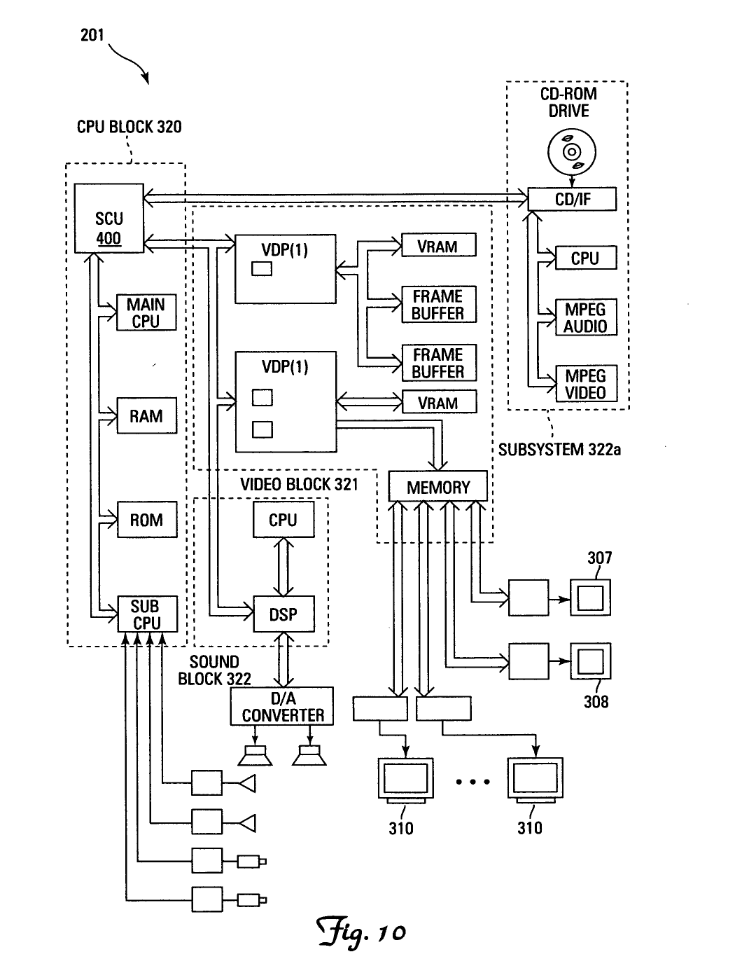

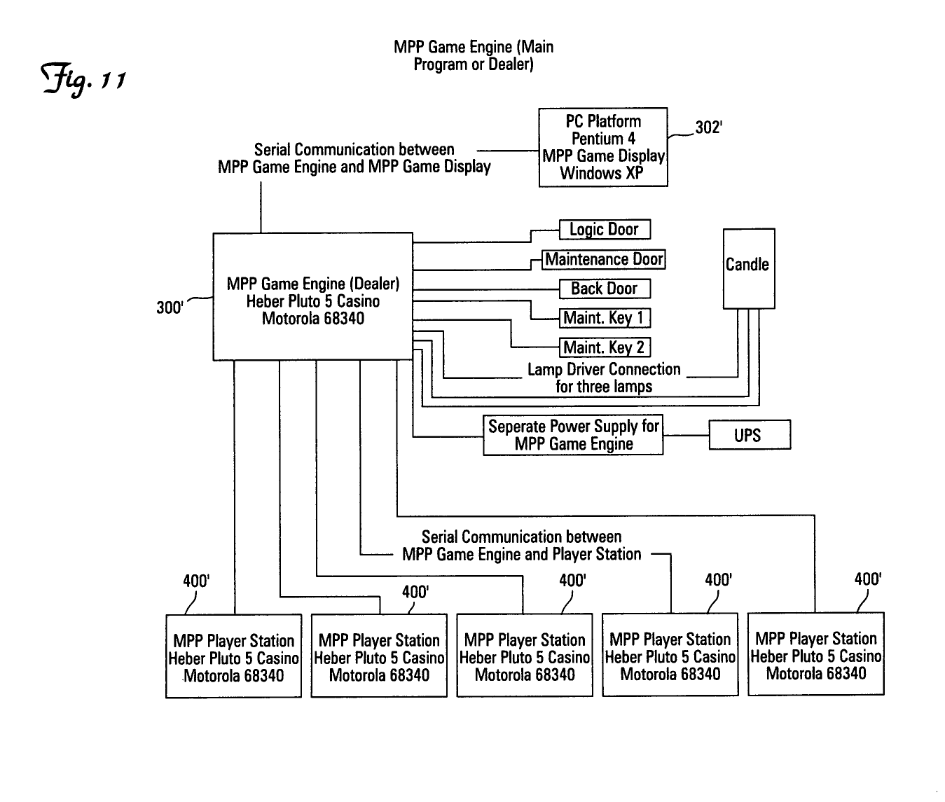

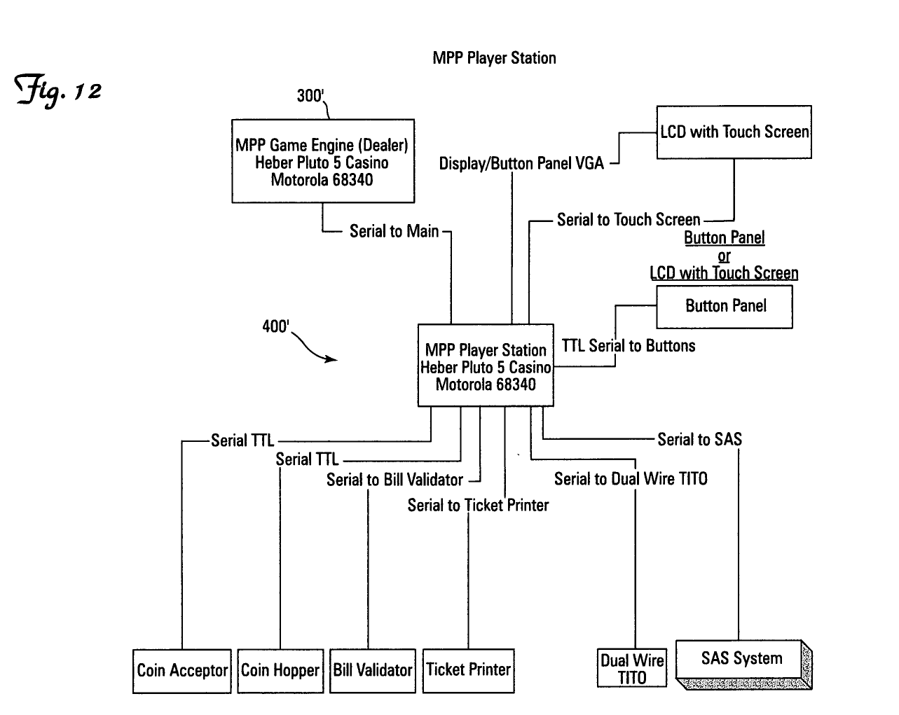

A schematic diagram of circuitry that may be used in system 301 is provided in FIG. 10 and described in detail in U.S. patent Publication 2003/0199316 A1. Among other things, the circuitry of system 301 includes a CPU block 320 for controlling the whole device, a video block 321 for controlling the items shown on displays and monitors 209, 210, 215 (FIGS. 8 and 9), a sound block 322 for producing sounds associated with the game (e.g., sound effects, verbal comments made by the virtual dealer, etc.), and a subsystem 322a for reading out CD-ROM. Notably, most, if not all signals are communicated to and processed by a system control unit (SCU) 400.

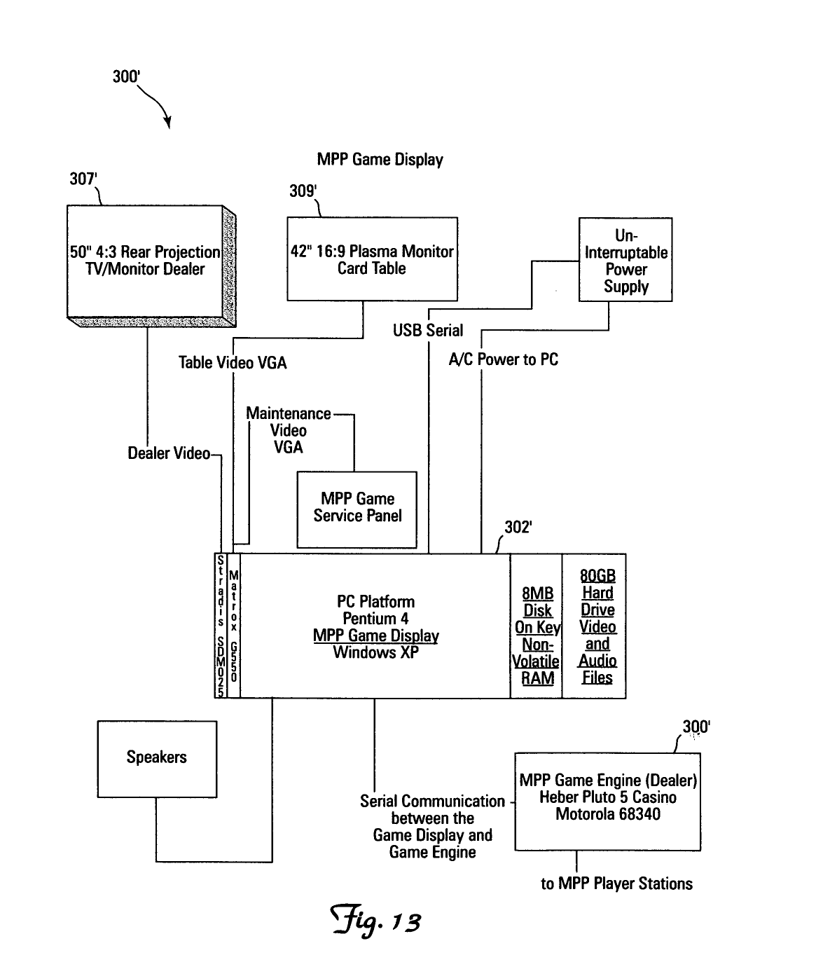

Turning now to FIGS. 11 through 13, the control system of the MPP system will now be described. The MPP game system 201 may be used to implement game play in accordance with teachings of the present invention is shown. While various features of system 201 are described herein, further detail is provided in U.S. patent Publication 2006/0025191 A1.

FIG. 13 shows an electronic/processor schematic diagram for a preferred processing system of the MPP platform. System 201 includes a game engine 300, which is also referred to herein as “the dealer” 300. The dealer 300 operates in conjunction with a display processor 302. Display processor 302 directs activities in such a way (i.e., directly, without involvement by the dealer 300) as to free up resources for the dealer 300. As can be seen from the electronic/processing schematics of FIG. 13, player station controllers 400 that are associated with the different player stations communicate directly with the dealer 300. The manner in which the dealer 300 is associated with display processor 302 and player station controllers 400 eliminates the need for a main game processor (e.g., the system control unit shown in FIG. 12) to activate controls individually and in sequence, at different player stations while controls at all of the other player stations are inactive. Each player station controller 400 also receives data from various player input components (e.g., the illustrated coin acceptor, coin hopper, bill validator, ticket printer, touch screen/display button panel, dual wire ticket in/ticket out (TITO) device, SAS system (an example of a standard communications protocol used by the central computer systems of a number of casinos), etc. as shown in FIG. 12.

Further details of system 201, including operation thereof, as well as of other alternative automated game systems that may implement a game of the present invention, are described in detail in U.S. patent Publication 2006/0025191 A1.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

What is claimed is:

1. A method of playing a casino card game, comprising:
each player making an Ante wager to participate in the game;
the player receiving at least a partial hand of cards;
the player viewing a first portion of his hand;
after the first portion of the hand is reviewed, the player making a first Play wager that is a multiple of his Ante wager or folding;
the player viewing a second portion of his hand;
after the second portion of his hand is viewed, the player making a second Play wager that is a multiple of his first Play wager or folding;
the player viewing a final portion of his hand; and
paying the player a payout when a composition of the hand is at least one of: a predetermined minimum winning rank, at most a predetermined maximum rank, and both.

2. The method of claim 1, wherein the hand composition is one of a plurality of 5-card poker rankings.

3. The method of claim 1, wherein at least a portion of the hand comprises community cards.

4. The method of claim 1, wherein all of the cards in the hand are dealt to the player.

5. The method of claim 1, and further comprising the step of discarding a card and drawing a new card prior to paying a payout.

6. The method of claim 1, wherein the player must elect to play against a maximum rank or a minimum rank.

7. The method of claim 1, wherein the player is permitted to play simultaneously against a maximum rank or a minimum rank.

8. The method of claim 1, wherein the player hand consists of five cards.

9. The method of claim 8, wherein the player hand consists of three player cards and two community cards.

10. The method of claim 1, wherein the first and second Play wager multiples are selected by the player without restriction.

11. The method of claim 10, wherein players may elect 2× multiples under at least one condition, and if the condition is not met, the multiples must be 1×.

12. The method of claim 1, wherein the multiple on the first Play wager is selected from the group consisting of 1, 2, 3, 4 or 5.

13. The method of claim 1, wherein the multiple on the second Play wager is selected from the group consisting of 1, 2, 3, 4 or 5.

14. The method of claim 1, wherein the multiple on the first and second Play wagers are selected from the group consisting of 1 and 2.

15. A computerized video gaming machine, comprising:
a plurality of player controls;
a player display;
a processor programmed to execute the method of claim 1.

16. The video gaming machine of claim 15, wherein the game is a single player gaming machine.

17. The video gaming machine of claim 15, wherein the game is a multiple player interactive gaming machine.

18. A method of playing a poker-style card game, comprising:
a player placing an Ante wager to participate in the game;
dealing three individual cards to each participating player and dealing three common cards;
after viewing the cards, each player electing to fold or place a “Fourth Street” wager equal to a multiple of the Ante, the multiple selected from the group consisting of 1× and 2×,
revealing an identity of a first common card after all “Fourth Street” wagers have been placed;
after viewing the common card, each player electing to fold or place a “Fifth Street” wager equal to a multiple of the “Fourth Street” wager, the multiple selected from the group consisting of 1× and 2×;
revealing an identity of the second common card; and
resolving the Ante, “Fourth Street” and “Fifth Street” wagers against a high hand pay table and a low hand pay table.

19. The method of claim 18, and further comprising:
permitting each player to place a bonus wager on the occurrence of one of a predetermined plurality of winning hands.

20. The method of claim 19, wherein the winning hands are three card hands and the player cards are used to determine the winning hands.
